(19) United States
(12) Patent Application Publication
(10) Pub. No.: US 2024/0117911 A1
(43) Pub. Date: Apr. 11, 2024

(54) EMERGENCY RELEASE AND COUPLING DEVICE

(71) Applicant: L'AIR LIQUIDE, SOCIETE ANONYME POUR L'ETUDE ET L'EXPLOITATION DES PROCEDES GEORGES CLAUDE, Paris (FR)

(72) Inventors: Gaetan COLEIRO, Sassenage (FR); Yan PENNEC, Sassenage (FR)

(73) Assignee: L'AIR LIQUIDE, SOCIETE ANONYME POUR L'ETUDE ET L'EXPLOITATION DES PROCEDES GEORGES CLAUDE, Paris (FR)

(21) Appl. No.: 18/273,114

(22) PCT Filed: Jan. 17, 2022
(86) PCT No.: PCT/EP2022/050825

§ 371 Date: Jul. 19, 2023

(30) Foreign Application Priority Data
Jan. 19, 2021 (FR) FR2100472

(51) Int. Cl. F16L 37/35

(52) U.S. Cl. CPC F16L 37/35; F16L 2201/20

(57) ABSTRACT

Self-closing emergency release and coupling device for the transport of cryogenic fluid comprising two pipes extending in a longitudinal direction and each comprising, at a connection end, a valve mechanism configured to automatically close the pipe when the connection ends are separated and to open the pipe when the connection ends are coupled, the device further comprising a tube arranged around each pipe and defining a vacuum space for thermally insulating the pipeline, the device is characterized in that it further comprises a chamber disposed around the valve mechanism and delimited by a wall assembly located between the outer tube and the transport pipe, the volume of the insulation chamber being independent of the vacuum space between the outer tube and the transport pipe.

### CROSS REFERENCE TO RELATED APPLICATIONS

This application is a § 371 of International PCT Application PCT/EP2022/050825, filed Jan. 17, 2022, which claims the benefit of FR2100472, filed Jan. 19, 2021, both of which are herein incorporated by reference in their entireties.

### FIELD OF THE INVENTION

The invention relates to an emergency release and coupling device.

### SUMMARY OF THE INVENTION

In certain embodiments, the invention relates more particularly to a self-closing emergency release and coupling device for the transport of cryogenic fluid, comprising two fluid transport pipes extending along a longitudinal direction and each comprising, at a connection end, a check valve mechanism configured to automatically close the pipe when the connection ends are separated and to open the pipe when the connection ends are coupled, the device moreover comprising an external tube that is disposed around each transport pipe and defines a space under vacuum for the thermal insulation of the transport pipe.

The invention relates to a system of one or more ducts for transporting cryogenic fluid (for example liquefied hydrogen) that is insulated so as to limit inputs of heat and enables the disconnection of the ducts in the event of an emergency without loss or outflow of fluid.

These devices are generally denoted by the term “breakaway” (cf. for example EP3581839 A1). The known devices have relatively unsatisfactory thermal performance and/or a complex structure and/or disadvantageous ergonomics of use.

An aim of certain embodiments of the present invention is to overcome all or some of the drawbacks of the prior art that are set out above.

In an effort to overcome the deficiencies of the prior art discussed supra, the coupling device according to certain embodiments of the invention, which is otherwise in accordance with the generic definition thereof given in the preamble above, can include a thermal insulation chamber disposed around the check valve mechanism and delimited by an assembly of one or more walls that is/are located between the external tube and the transport pipe, the volume of the insulation chamber being independent of the space under vacuum located between the external tube and the transport pipe.

Furthermore, embodiments of the invention may have one or more of the following features:
the device has a thermal insulation chamber at each connection end, the volume of each thermal insulation chamber being delimited by tubular walls that extend longitudinally and are spaced apart transversely, a first end of the volume of each thermal insulation chamber located at the connection end being open, the opposite second longitudinal end being closed, the open first ends of the two thermal insulation chambers being configured to be connected to one another in a sealed manner and to form a single sealed and closed insulation volume when the connection ends are coupled,
the device comprises a system for evacuating the insulation volume formed by the two thermal insulation chambers when the connection ends are coupled, the evacuation system comprising a fluid transfer channel comprising an end leading into said volume,
the mechanical link between the external tube and the transport pipe comprises the assembly of one or more walls delimiting the insulation chamber and forms a thermal path producing at least one back-and-forth along the longitudinal direction, for example a thermal path in an “S” shape along a longitudinal section,
at least part of the assembly of one or more walls delimiting the insulation chamber and/or the interior of the insulation chamber comprises a thermal insulation of multilayer type (“MLI”),
the assembly of one or more walls delimiting the insulation chamber ensures the retention of the transport pipe in the external tube via mechanical links between on the one hand the assembly of walls and, on the other hand, the transport pipe and the external tube, said mechanical links being located essentially or solely at the connection end,
the ends of the external tubes and of the transport pipes that are intended to be coupled have one or more respective mounting flanges,
the assembly of one or more mounting flanges comprises an internal flange of annular shape which is fixed to the end of the internal tube via an assembly of one or more mounting members, such as screws, which make it possible to access the check valve mechanism and seals of the device when the flange is dismounted,
the assembly of one or more walls delimiting the insulation chamber is mechanically linked to the transport pipe and to the external tube by welding,
when the connection ends are coupled, the ends of the two external tubes are linked in a sealed manner and the ends of the two transport pipes are linked in a sealed manner,
the check valve mechanism comprises a check valve urged toward a closed position against a seat by a return member,
the terminal ends of the check valves of the two transport pipes are configured to come into contact and mechanically push one another back out of the respective seats counter to the return members when the connection ends are coupled,
the space under vacuum between the external tube and the transport pipe comprises a multilayer thermal insulator, “MLI”,
the thermal insulation chamber comprises a safety relief valve configured to discharge any overpressure beyond a determined threshold.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 shows a schematic and partial view in longitudinal section, illustrating an exemplary embodiment of a coupling device according to the invention in a separated state.

FIG. 2 shows a schematic and partial view in longitudinal section, illustrating another exemplary embodiment of a coupling device according to the invention in a coupled state.

FIG. 3 shows a schematic and partial view in longitudinal section of a detail of the device, illustrating a possible exemplary embodiment of the structure of the insulation chamber.

FIG. 4 shows a schematic and partial view in longitudinal section, illustrating another exemplary embodiment of a coupling device according to the invention in a coupled state.

### DETAILED DESCRIPTION OF THE INVENTION

The self-closing emergency release and coupling device 1 for the transport of cryogenic fluid that is illustrated comprises two fluid transport pipes 2, 3 extending along a longitudinal direction A. Each transport pipe 2, 3 may be composed of stainless steel or any other material compatible with cryogenic temperatures (less than −100° C., for example).

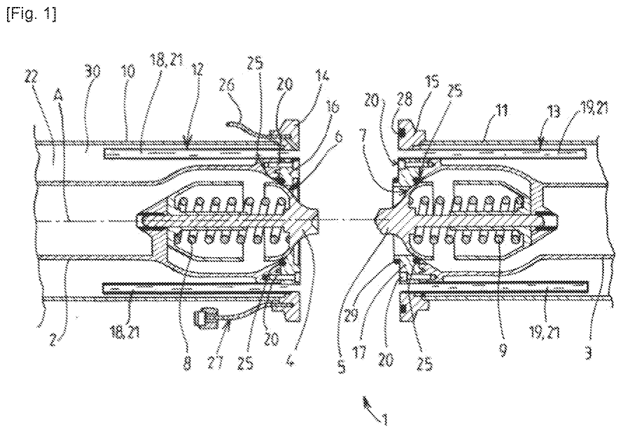

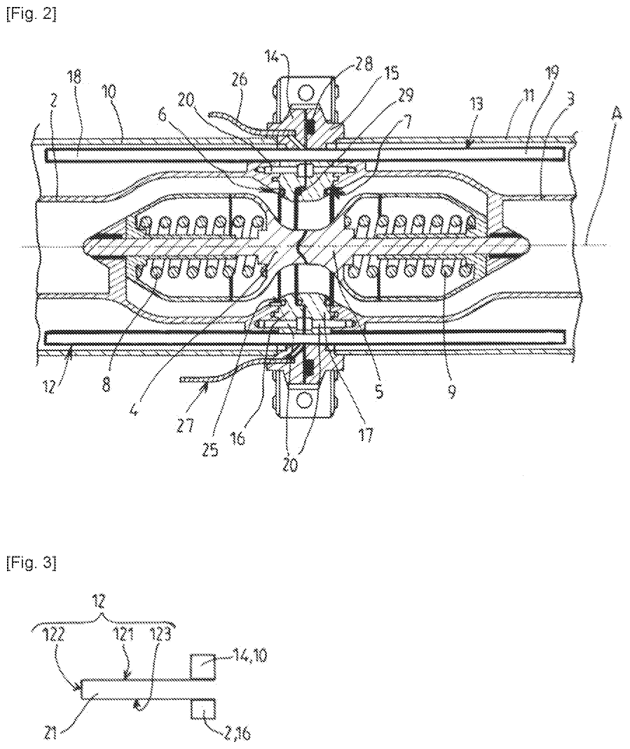

Each transport pipe 2, 3 comprises, at a connection end, a check valve mechanism 4, 6, 8; 5, 7, 9 configured to automatically close the pipe when the connection ends are separated (cf. [FIG. 1]) and to open when the connection ends are coupled (cf. [FIG. 2]).

The check valve mechanism may comprise a check valve 4, 5 urged toward a closed position against a seat 6, 7 by a return member 8, 9, such as a spring, notably a compression spring.

The terminal ends of the check valves 4, 5 of the two transport pipes 2, 3 are configured to come into contact and mechanically push one another back out of the respective seats counter to the return members 5, 9 when the connection ends are coupled.

For example, the terminal ends of the check valves 4, 5 of the two pipes 2, 3 longitudinally project beyond the ends of the transport pipes 2, 3 (and may have complementary shapes, where appropriate).

The device 1 moreover comprises an external tube 10, 11 (made of stainless steel, metal or other) that is disposed around each transport pipe 2, 3 (for example concentrically) and defines a space under vacuum between around the transport pipe 2, 3 for the thermal insulation of the latter.

This space under vacuum may contain a thermal insulator 22, for example of multilayer type (Mil).

The device 1 moreover may include a thermal insulation chamber 18, 19 disposed around each check valve mechanism and delimited by an assembly of one or more walls 12, 13 located between the external tube 10, 11 and the transport pipe 2, 3. This volume in the insulation chamber 18, 19 is preferably independent of the space under vacuum located between the external tube 10, 11 and the transport pipe 2, 3.

As illustrated, the volume of each thermal insulation chamber 18, 19 may be delimited by tubular walls that extend longitudinally and are spaced apart transversely (the volume of the chamber 18, 19 may thus be delimited between two spaced-apart portions of cylinders).

For example, a first end of the volume of each thermal insulation chamber 18, 19 located at the connection end is open (cf. [FIG. 1]). The opposite second longitudinal end may for its part be closed in a sealed manner.

The open first ends of the two thermal insulation chambers 18, 19 may be configured to be connected to one another in a sealed manner and to form a single sealed and closed insulation volume when the connection ends are coupled (cf. [FIG. 2]).

Preferably, the device 1 comprises a system for evacuating this insulation volume formed by the two thermal insulation chambers 18, 19 when the connection ends are coupled; this evacuation system comprises, for example, a fluid transfer channel 26 comprising an end leading into said volume and another end that can be linked to a pumping member, for example. This makes it possible to produce a closed volume under vacuum, which is independent of the vacuum located between the external tube 10, 11 and the transport pipe 2, 3. A safety non-return check valve system may be provided for this volume of vacuum.

Similarly, the thermal insulation chamber 18, 19 may comprise a safety relief valve system configured to discharge any overpressure beyond a determined threshold (passing through a distinct or identical channel 27).

This closed insulation volume forms an additional thermal insulation screen around the check valve mechanism and a thermal insulation path between the hot (external) part and the cold (internal) part of the device, as will be described in more detail below.

At least part of the assembly of one or more walls 12, 13 delimiting the insulation chamber 18, 19 and/or the interior of the insulation chamber 18, 19 may comprise a thermal insulation 21 of multilayer type (“MLI”), for example.

Specifically and advantageously, the mechanical link between the external tube 10, 11 and the transport pipe 2, 3 may comprise or be made up of the assembly of one or more walls 12, 13 delimiting the insulation chamber 18, 19. This assembly of walls may thus form a thermal path producing at least one back-and-forth along the longitudinal direction, for example a thermal path in an “S” shape along a longitudinal section.

Preferably, the walls are composed of metal, stainless steel or any other suitable material and may have a thickness of between 0.3 mm and 0.5 mm and a length of between 10 mm and 500 mm. This configuration constitutes an insulating thermal path between its two ends.

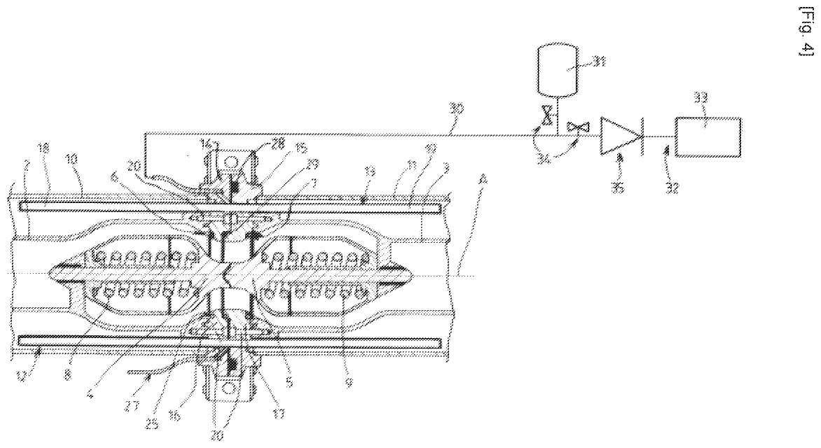

As a result, giving consideration, for example, to the pipe illustrated on the left, a first longitudinal wall 121 may be linked (welded for example) at a right-hand end to the terminal end of the external tube 10 (or a flange 14 fixed to this end); cf. also [FIG. 3]. The second end of this first wall (on the left) may be linked an angle 122 toward the inside of the pipe 10 (second transverse wall). Then, a third longitudinal wall 123 may be linked (welded for example) at this second wall. The second end (on the right) of this third wall 123 may be linked (welded for example) at the terminal end of the external tube 10 of the transport pipe 2, 3 (on the right, or a flange 16 fixed to this end). As a result, this assembly of one or more walls 12, 13 delimiting the insulation chamber 18, 19 may be mechanically linked at the terminal end of the pipe (likewise for the right-hand other pipe).

As a result, the assembly of one or more walls 12, 13 delimiting the insulation chamber 18, 19 can ensure at least partially the retention of the transport pipe 2, 3 in the external tube 10, 11 via mechanical links (welding or otherwise) between on the one hand the assembly of walls 12, 13 and, on the other hand, the transport pipe 2, 3 and the external tube 10, 11 (and/or flanges). The mechanical links may be situated essentially or solely at the connection end.

As a result, the assembly of one or more walls 12, 13 delimiting the insulation chamber 18, 19 may be mechanically linked to the transport pipe 2, 3 and to the external tube 10, 11 by welding.

As illustrated and mentioned above, the ends of the external tubes 10, 11 and of the transport pipes 2, 3 that are intended to be coupled may have one or more respective mounting flanges 14, 15, 16, 17.

For example, an internal flange 16, 17 of annular shape is fixed to the end of the internal tube 2, 3 via an assembly of one or more mounting members 20, such as screws, which preferably make it possible to access the check valve mechanism 4, 6, 8; 5, 7, 9 and any seals of the device 1 when the flange 16, 17 is dismounted. This facilitates maintenance. In particular, the screws 20 in terms of their threading may be oriented longitudinally toward the inside of the pipe.

When the connection ends are coupled, the ends of the two external tubes 10, 11 are linked in a sealed manner and the ends of the two transport pipes 2, 3 are linked in a sealed manner. This can be obtained by an assembly of suitable seals.

For example, the sealing between the external tubes 10, 11 may be ensured at least partially by one or more seals 28 at ambient temperature, interposed between the external flanges 14, 15 (seals of the type made of polymer or other). This location at the largest diameter of the device 1 enables improved management of thermal expansions. In particular, the rate of leakage is reduced since the seal contracts toward the inside and increases the forces in the direction of the sealing.

The sealing between the two transport pipes 2, 3 may for its part be ensured at least partially by one or more seals 29 interposed between the internal flanges 16, 17, for example a metal cryogenic seal, notably of “C” or radial type.

The sealing between the check valve 4, 5 and its seat (formed for example by the internal flange) may have a lip seal 25 (for example made of energized polymer or PTFE). Said seal 25 may form the seat and is advantageously located on the internal flange 16, 17, on a face of said internal flange 16, 17 and oriented toward the inside of the transport pipe 2, 3. This protects these sensitive sealing elements from shocks, scratches and dirt. The force of the spring 8, 9 enables sealed closure between the flange 16 and the check valve 4, 5, via the seal 25, without risk of leakage.

This ensures considerable reliability after multiple opening/closing cycles and sealing at any temperature level. The positioning of the check valve is facilitated, which can withstand large pressure differentials.

The device 1 has good-quality insulation compatible with cryogenic temperatures, automatic opening or closing of the check valves, and considerable reliability.

In particular, in the event of loss of vacuum owing to a leakage of liquid, the pressure of the independent volume of the insulation chamber 18, 19 cannot rise. This prevents accidents.

As illustrated schematically in [FIG. 4], the device preferably comprises a purge system for the sealed insulation volume. This purge system may have a fluidic circuit linked to the insulation volume (for example leading into the insulation volume).

This purge makes it possible to control the gaseous atmosphere in the insulation volume (nature of the gas and/or pressure within it). For example, the gaseous insulation volume may be evacuated (to a pressure lower than atmospheric pressure), or pressurized with a purge gas (to a pressure greater than atmospheric pressure) and the purge gas may be a gas having a boiling point equal to or less than that of the gas transported. In this example, this gas may be hydrogen, helium or a mixture of the two.

As illustrated, the purge system may comprise a transfer pipe 30 leading into the insulation volume and a reservoir 31 of pressurized purge gas (hydrogen or helium, for example) linked to this transfer pipe 30, for example via at least one valve 34. In this way, the reservoir 31 can supply a stream of purge gas toward the insulation volume.

The purge gas may be extracted toward a discharge means, for example another end 32 of the transfer pipe 30. This discharge end 32 may be equipped with a non-return valve 34 and/or check valve 35 controlling the stream toward a vent 33 (atmosphere or evacuation system) and/or a pumping member 33, for example a vacuum pump.

This makes it possible to discharge the purge gas that has purged the insulation volume and/or to pump it.

This makes it possible to configure the insulation volume for perfect insulation and in complete safety.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-16. (canceled)

17. A self-closing emergency release and coupling device for the transport of cryogenic fluid, comprising:
two fluid transport pipes extending along a longitudinal direction and each comprising, at a connection end, a check valve mechanism configured to automatically close the pipe when the connection ends are separated and to open the pipe when the connection ends are coupled;
the device moreover comprising an external tube that is disposed around each transport pipe and defines a space under vacuum for the thermal insulation of the transport pipe;
one or more thermal insulation chambers disposed around the check valve mechanism and delimited by an assembly of one or more walls that is/are located between the external tube and the transport pipe, a volume of each thermal insulation chamber being independent of a space under vacuum located between the external tube and the transport pipe, wherein each thermal insulation chamber is disposed at each connection end, wherein the volume of each thermal insulation chamber is delimited by tubular walls that extend longitudinally and are spaced apart transversely;
a first end of the volume of each thermal insulation chamber is located at the connection end being open, the opposite second longitudinal end being closed, the open first ends of the two thermal insulation chambers being configured to be connected to one another in a sealed manner and to form a single sealed and closed insulation volume when the connection ends are coupled; and
a purge system for the insulation volume, the purge system comprising a fluidic circuit fluidically connected to said insulation volume.

18. The device as claimed in claim 17, wherein the purge system comprises a transfer pipe having an end leading into the insulation volume, a reservoir of purge gas under pressure connected to the transfer pipe and configured to enable the supply of purge gas to the insulation volume, the purge system comprising a discharge means for the purge gas.

19. The device as claimed in claim 18, wherein the discharge means for purge gas comprises at least one of the following: a vent connected to an extraction zone, for example the atmosphere, a pumping member, for example a vacuum pump.

20. The device as claimed in claim 17, further comprising a system for evacuating the insulation volume formed by the two thermal insulation chambers when the connection ends are coupled, the evacuation system comprising a fluid transfer channel comprising an end leading into said volume.

21. The device as claimed in claim 17, wherein that the fluidic circuit of the purge system comprises an assembly of one or more valves and/or an assembly of one or more check valves, notably one or more non-return check valves.

22. The device as claimed in claim 17, wherein the mechanical link between the external tube and the transport pipe comprises the assembly of one or more walls delimiting the insulation chamber and forms a thermal path producing at least one back-and-forth along the longitudinal direction, for example a thermal path in an “S” shape along a longitudinal section.

23. The device as claimed in claim 17, wherein at least part of the assembly of one or more walls delimiting the insulation chamber and/or the interior of the insulation chamber comprises a thermal insulation of multilayer type.

24. The device as claimed in claim 17, wherein the assembly of one or more walls delimiting the insulation chamber ensures the retention of the transport pipe in the external tube via mechanical links between on the one hand the assembly of walls and, on the other hand, the transport pipe and the external tube, said mechanical links being located essentially or solely at the connection end.

25. The device as claimed in claim 17, wherein the ends of the external tubes and of the transport pipes that are intended to be coupled have one or more respective mounting flanges.

26. The device as claimed in claim 25, wherein the assembly of one or more mounting flanges comprises an internal flange of annular shape which is fixed to the end of the internal tube via an assembly of one or more mounting members, such as screws, which make it possible to access the check valve mechanism and seals of the device when the flange is dismounted.

27. The device as claimed in claim 25, wherein the assembly of one or more walls delimiting the insulation chamber is mechanically linked to the transport pipe and to the external tube by welding.

28. The device as claimed in claim 17, wherein, when the connection ends are coupled, the ends of the two external tubes are linked in a sealed manner and the ends of the two transport pipes are linked in a sealed manner.

29. The device as claimed in claim 17, wherein the check valve mechanism comprises a check valve urged toward a closed position against a seat by a return member.

30. The device as claimed in claim 29, wherein the terminal ends of the check valves of the two transport pipes are configured to come into contact and mechanically push one another back out of the respective seats counter to the return members when the connection ends are coupled.

31. The device as claimed in claim 17, wherein the space under vacuum between the external tube and the transport pipe comprises a multilayer thermal insulator, “MLI”.

32. The device as claimed in claim 17, wherein the thermal insulation chamber comprises a safety relief valve configured to discharge any overpressure beyond a determined threshold.
